(19) United States
(12) Patent Application Publication
(10) Pub. No.: US 2023/0192230 A1
(43) Pub. Date: Jun. 22, 2023

(54) ELECTRONIC DEVICE FOR HUMAN-POWERED VEHICLE

(71) Applicant: Shimano Inc., Osaka (JP)

(72) Inventors: Ryota YAMAGUCHI, Osaka (JP); Hitoshi TAKAYAMA, Osaka (JP)

(21) Appl. No.: 18/075,612

(22) Filed: Dec. 6, 2022

(30) Foreign Application Priority Data
Dec. 17, 2021 (JP) 2021-205440

(51) Int. Cl. B62M 6/50; B62J 45/411; B62J 45/413

(52) U.S. Cl. CPC B62M 6/50; B62J 45/411; B62J 45/413; B62M 6/55

(57) ABSTRACT

An electronic device is provided to a human-powered vehicle. The electronic device basically includes an electronic controller. The electronic controller is configured to selectively operate in an operational state that includes a first operational state and a second operational state. The second operational state consumes more electric power than the first operational state. The electronic controller is configured to switch the operational state between the first operational state and the second operational state in accordance with a rotational amount of a rotational body included in a transmission path of a human driving force in the human-powered vehicle.

### CROSS-REFERENCE TO RELATED APPLICATIONS

This application claims priority to Japanese Patent Application No. 2021-205440, filed on Dec. 17, 2021. The entire disclosure of Japanese Patent Application No. 2021-205440 is hereby incorporated herein by reference.

### BACKGROUND

### Technical Field

The present disclosure generally relates to an electronic device for a human-powered vehicle.

### Background Information

European Patent No. 3566935 (Patent Document 1) discloses an example of a human-powered vehicle component including a controller that is switched from a first operational state to a second operational state that consumes more electric power than the first operational state in a case where an acceleration detected by an acceleration sensor is greater than or equal to a threshold value.

### SUMMARY

With the human-powered vehicle component disclosed in European Patent No. 3566935, for example, in a case where the human-powered vehicle is not traveling and is being transported, vibration of the human-powered vehicle will switch the electronic controller from the first operational state to the second operational state.

One objective of the present disclosure is to provide an electronic device for a human-powered vehicle that appropriately switches an electronic controller between multiple operational states.

An electronic device in accordance with a first aspect of the present disclosure is for a human-powered vehicle. The electronic device comprises an electronic controller configured to selectively operate in an operational state that includes a first operational state and a second operational state. The second operational state consumes more electric power than the first operational state. The electronic controller is further configured to switch the operational state between the first operational state and the second operational state in accordance with a rotational amount of a rotational body included in a transmission path of a human driving force in the human-powered vehicle.

With the electronic device according to the first aspect, the electronic controller switches the operational state in accordance with the rotational amount of the rotational body. This limits the switching of the operational state of the electronic controller caused by vibration of the human-powered vehicle. With the electronic device according to the first aspect, the electronic controller switches the operational state in accordance with the rotational amount of the rotational body. Thus, in a case where the rider is riding the human-powered vehicle and the human-powered vehicle is traveling, the operational state of the electronic controller is appropriately switched.

In accordance with a second aspect of the present disclosure, the electronic device according to the first aspect is configured so that the electronic controller is configured to switch the operational state from the first operational state to the second operational state a case where the operational state is the first operational state and the rotational amount becomes a first rotational amount or greater.

With the electronic device according to the second aspect, in the first operational state, the electronic controller does not switch the operational state until the rotational amount becomes the first rotational amount. This limits increases in power consumption in a case where the human-powered vehicle is stationary.

In accordance with a third aspect of the present disclosure, the electronic device according to the second aspect is configured so that the electronic controller is configured to switch the operational state from the first operational state to the second operational state in a case where the operational state is switched from the second operational state to the first operational state and the rotational amount then becomes greater than or equal to the first rotational amount.

With the electronic device according to the third aspect, in a case where the operational state is switched to the first operational state and the rotational amount then becomes greater than or equal to the first rotational amount, the electronic controller switches the operational state to the second operational state. Thus, in a case where the human-powered vehicle is driven by the human driving force of the rider, the operational state of the electronic controller is readily switched to the second operational state.

In accordance with a fourth aspect of the present disclosure, the electronic device according to the third aspect is configured so that the rotational body includes a crank. The first rotational amount includes at least one of the rotational amount of a case in which the crank is rotated in a first rotational direction that corresponds to a forward direction of the human-powered vehicle and the rotational amount of a case in which the crank is rotated in a second rotational direction that is opposite to the first rotational direction.

With the electronic device according to the fourth aspect, in a case where the crank is rotated in one of the first rotational direction and the second rotational direction and the rotational amount becomes greater than or equal to the first rotational amount, the operational state is switched from the first operational state to the second operational state.

In accordance with a fifth aspect of the present disclosure, the electronic device according to any one of the second to fourth aspects is configured so that the first rotational amount is greater than 0 degrees and less than or equal to 50 degrees.

In the electronic device according to the fifth aspect, the first rotational amount is greater than 0 degrees and less than or equal to 50 degrees. Thus, as compared to a case where the first rotational amount is greater than 50 degrees, the electronic controller promptly switches the operational state from the first operational state to the second operational state. This improves usability.

In accordance with a sixth aspect of the present disclosure, the electronic device according to the fifth aspect is configured so that the first rotational amount is greater than or equal to 10 degrees and less than or equal to 40 degrees.

In the electronic device according to the sixth aspect, the first rotational amount is less than or equal to 40 degrees. Thus, the electronic controller promptly switches the operational state from the first operational state to the second operational state. In the electronic device according to the sixth aspect, the first rotational amount is greater than or equal to 10 degrees. This limits the switching of the electronic controller from the first operational state to the second operational state that would result from external causes other than the rider.

In accordance with a seventh aspect of the present disclosure, the electronic device according to any one of the first to sixth aspects is configured so that the electronic controller is configured to switch the operational state from the second operational state to the first operational state in a case where the operational state is the second operational state and a predetermined condition is satisfied. The predetermined condition includes at least one of a first condition that the rotational amount in a first period is less than a second rotational amount, a second condition that the human driving force in a second period is less than or equal to a predetermined human driving force, and a third condition that a predetermined first signal is not input to the electronic controller in a third period.

With the electronic device according to the seventh aspect, the electronic controller appropriately switches the operational state from the second operational state to the first operational state in accordance with at least one of the first condition, the second condition, and the third condition.

In accordance with an eighth aspect of the present disclosure, the electronic device according to the seventh aspect is configured so that the predetermined condition includes the third condition. The predetermined first signal includes a wireless communication signal received by a wireless communication device.

With the electronic device according to the eighth aspect, the electronic controller appropriately switches the operational state from the second operational state to the first operational state in accordance with the wireless communication signal.

In accordance with a ninth aspect of the present disclosure, the electronic device according to any one of the first to eighth aspects is configured so that the human-powered vehicle further includes a battery. The electronic controller is configured to be supplied with electric power from the battery in the first operational state.

With the electronic device according to the ninth aspect, the electronic controller switches the operational state from the first operational state to the second operational state using electric power supplied from the battery in the first operational state.

In accordance with a tenth aspect of the present disclosure, the electronic device according to any one of the first to ninth aspects further comprises a detector configured to detect the rotational amount.

With the electronic device according to the tenth aspect, the detector appropriately detects the rotational amount of the rotational body.

In accordance with an eleventh aspect of the present disclosure, the electronic device according to the tenth aspect is configured so that the detector includes an acceleration sensor.

With the electronic device according to the eleventh aspect, the rotational amount of the rotational body is appropriately detected by the acceleration sensor.

In accordance with a twelfth aspect of the present disclosure, in the electronic device according to the eleventh aspect, the acceleration sensor is configured to detect acceleration of at least three axes.

With the electronic device according to the twelfth aspect, the acceleration sensor detects acceleration of three or more axes of the rotational body. Thus, the detector appropriately detects the rotational amount of the rotational body regardless of the mount state of the electronic device.

In accordance with a thirteenth aspect of the present disclosure, in the electronic device according to the eleventh or twelfth aspect, the detector is configured to transmit a second signal related to the rotational amount calculated from a detection result of the acceleration sensor to the electronic controller.

With the electronic device according to the thirteenth aspect, the detector transmits the second signal to the electronic controller. Thus, the electronic controller does not have to calculate the rotational amount from the acceleration. This reduces the calculation load on the electronic controller.

In accordance with a fourteenth aspect of the present disclosure, in the electronic device according to the thirteenth aspect, the detector is configured to transmit the second signal to the electronic controller in a case where the rotational amount becomes a predetermined third rotational amount.

With the electronic device according to the fourteenth aspect, the electronic controller does not have to perform calculations related to the predetermined third rotational amount. This reduces the calculation load on the electronic controller.

In accordance with a fifteenth aspect of the present disclosure, the electronic device according to any one of the first to fourteenth aspects further comprises a human force sensor configured to output a signal corresponding to the human driving force and configured to be provided on at least one of a crank arm of the human-powered vehicle and a pedal of the human-powered vehicle.

With the electronic device according to the fifteenth aspect, human driving force is appropriately detected by the human force sensor.

In accordance with a sixteenth aspect of the present disclosure, the electronic device according to the fifteenth aspect is configured so that the electronic controller is connected to the human force sensor and configured to output information related to the human driving force in accordance with a third signal received from the human force sensor.

With the electronic device according to the sixteenth aspect, the information related to the human driving force output from the electronic controller is used to improve convenience for a user.

In accordance with a seventeenth aspect of the present disclosure, in the electronic device according to any one of the first to sixteenth aspects, the electronic controller is configured to control a motor that applies a propulsion force to the human-powered vehicle.

The electronic device according to the seventeenth aspect appropriately switches the operational state of the electronic controller that is configured to control the motor, which applies propulsion force to the human-powered vehicle.

In accordance with an eighteenth aspect of the present disclosure, in the electronic device according to any one of the first to seventeenth aspects, the electronic controller is configured to output information related to rotational speed of the rotational body in accordance with the rotational amount.

With the electronic device according to the eighteenth aspect, the information related to rotational speed of the rotational body output from the electronic controller is used to improve convenience for a user.

According to the present disclosure, the electronic device for a human-powered vehicle appropriately switches the electronic controller between multiple operational states.

### BRIEF DESCRIPTION OF THE DRAWINGS

Referring now to the attached drawings which form a part of this original disclosure.

FIG. 1 is a perspective view of a crank assembly on a human-powered vehicle electronic device is provided in accordance with a first embodiment.

FIG. 2 is a perspective view of the electronic device and a crank arm shown in FIG. 1.

FIG. 3 is a cross-sectional view of the electronic device and the crank arm shown in FIG. 1.

FIG. 4 is a block diagram showing the electrical configuration of a human-powered vehicle including the human-powered vehicle electronic device shown in FIG. 1.

FIG. 5 is a flowchart of a process for switching an operational state executed by an electronic controller shown in FIG. 4.

FIG. 6 is a side elevational view of a human-powered vehicle including a human-powered vehicle electronic device in accordance with a second embodiment.

FIG. 7 is a perspective view of a drive unit shown in FIG. 6.

FIG. 8 is a cross-sectional view of the drive unit shown in FIG. 7.

FIG. 9 is a block diagram showing the electrical configuration of the human-powered vehicle including the human-powered vehicle electronic device of the second embodiment.

FIG. 10 is a time chart showing the relationship between a rotational amount that is calculated by a detector and a second signal that is output from the detector in a modified example.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

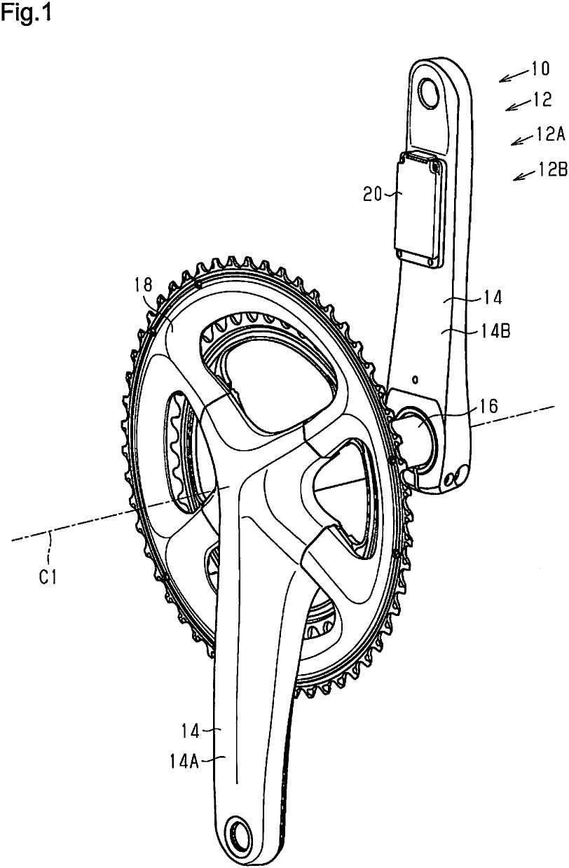

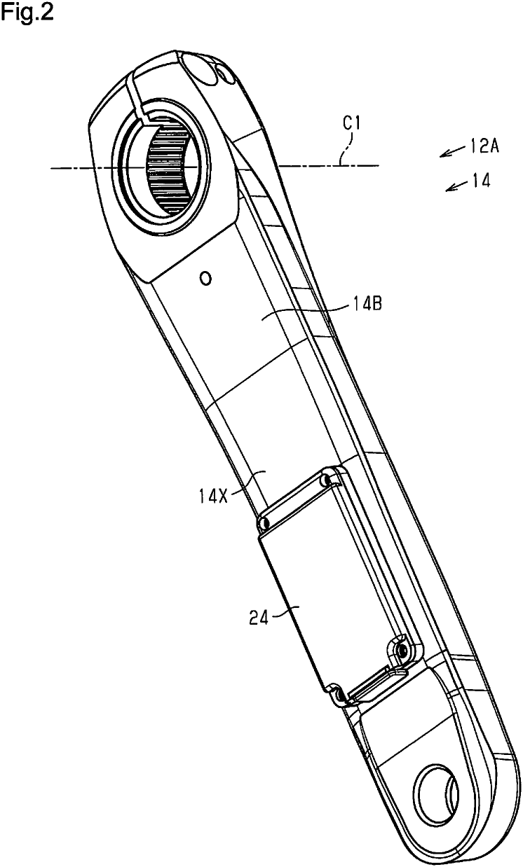

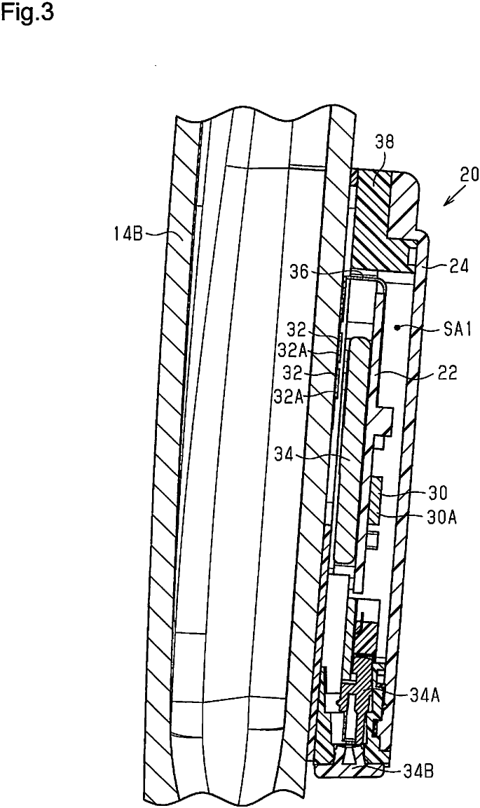

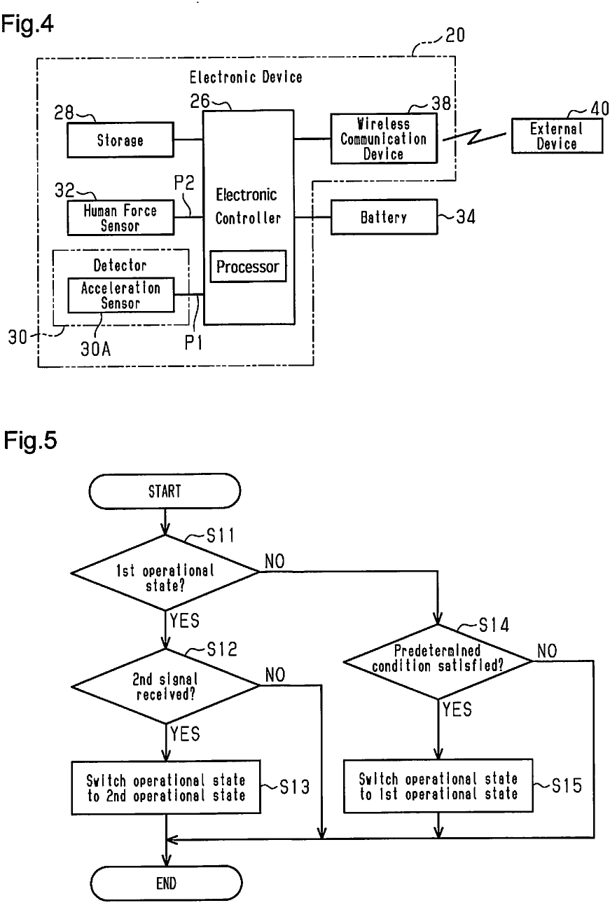

A first embodiment of an electronic device 20 for a human-powered vehicle will now be described with reference to FIGS. 1 to 5. A human-powered vehicle 10 is a vehicle including at least one wheel and driven by at least human driving force. The human-powered vehicle 10 includes, for example, various types of bicycles such as a mountain bike, a road bike, a city bike, a cargo bike, a hand bike, and a recumbent bike. The number of wheels on the human-powered vehicle 10 is not limited. The human-powered vehicle 10 includes, for example, a monocycle and a vehicle including two or more wheels. The human-powered vehicle 10 is not limited to a vehicle configured to be driven only by a human driving force. The human-powered vehicle 10 includes an E-bike that uses driving force of an electric motor in addition to a human driving force for propulsion. The E-bike includes an electric assist bicycle that assists in propulsion with an electric motor. In the embodiments described below, the human-powered vehicle 10 refers to an electric assist bicycle.

The human-powered vehicle 10 includes a human-powered vehicle component 12. Preferably, the component 12 includes at least a portion of a crank assembly 12B. The crank assembly 12B includes a crank 12A. The crank 12A includes two crank arms 14 and a crank axle 16. In the present embodiment, the component 12 includes one of the crank arms 14. The human-powered vehicle 10 further includes at least one front sprocket 18. The at least one front sprocket 18 can be included in the crank assembly 12B.

The two crank arms 14 includes a first crank arm 14A and a second crank arm 14B. The at least one front sprocket 18 is coupled to the first crank arm 14A. The first crank arm 14A and the at least one front sprocket 18 can be formed integrally, or can be formed separately and coupled to each other. Each of the first crank arm 14A and the second crank arm 14B is provided on an axial end of the crank axle 16. Pedals are separately coupled to the first crank arm 14A and the second crank arm 14B. In the present embodiment, the component 12 includes the second crank arm 14B.

A human driving force is input to the two crank arms 14 and the crank axle 16. The crank axle 16 is provided on the human-powered vehicle 10 so as to be rotated by the input human driving force. For example, in a state where the crank axle 16 is provided on the human-powered vehicle 10, the crank axle 16 is rotatable about a rotational axis C1. The axis of the crank axle 16 conforms to the rotational axis C1.

The human-powered vehicle 10 includes multiple wheels. The multiple wheels include a rear wheel and a front wheel. The rear wheel is supported by a frame of the human-powered vehicle 10. The rear wheel is driven in accordance with rotation of the crank axle 16. The crank axle 16 and the rear wheel are coupled by a drive mechanism. The drive mechanism includes the front sprocket 18. The crank axle 16 and the front sprocket 18 are coupled so as to rotate integrally. The drive mechanism can include a pulley or bevel gear instead of the front sprocket 18. The drive mechanism further includes a rear sprocket and a chain. The chain transmits rotational force of the front sprocket 18 to the rear sprocket. The drive mechanism can include a pulley or a bevel gear instead of the rear sprocket. The drive mechanism can include a belt or a shaft instead of the chain.

The human-powered vehicle 10 includes an electronic device 20. In an example, the electronic device 20 includes a substrate 22. The substrate 22 includes a printed wiring board. In an example, the electronic device 20 is provided on the component 12 and is rotatable relative to the frame of the human-powered vehicle 10 in a circumferential direction with respect to the rotational axis C1.The electronic device 20 is provided on at least one of the crank arms 14. The electronic device 20 is provided on at least one of the first crank arm 14A and the second crank arm 14B. In the present embodiment, the electronic device 20 is provided on the second crank arm 14B. The electronic device 20 rotates relative to the frame of the human-powered vehicle 10 about the axis of the crank axle 16 in accordance with rotation of the two crank arms 14. Thus, the electronic device 20 rotates in the circumferential direction with respect to the rotational axis C1.

In an example, the electronic device 20 includes a cover member 24. In an example, the cover member 24 is provided on an intermediate part of the crank arm 14 in a direction in which the crank arm 14 extends. In an example, the cover member 24 is fixed to an outer surface of the crank arm 14. In a state where the crank assembly 12B is coupled to the human-powered vehicle 10, the cover member 24 is attached to the outer surface of the crank arm 14 on a side surface 14X that extends through a width-wise center of the human-powered vehicle 10 and faces a center plane that is orthogonal to the width-wise direction of the human-powered vehicle 10. The cover member 24 is formed from resin. The cover member 24 defines an accommodation space SA1. The cover member 24 can be formed of multiple members or can be formed of a single member.

The electronic device 20 includes an electronic controller 26. In an example, the electronic controller 26 is disposed in the accommodation space SA1. The electronic controller 26 includes at least one processor that executes a predetermined control program. The processor includes, for example, a central processing unit (CPU) or a micro processing unit (MPU). The electronic controller 26 can include one or more microcomputers. The electronic controller 26 can include multiple processors located at separate locations. The electronic controller 26 is formed of one or more semiconductor chips that are mounted on the substrate 22. Thus, the terms “electronic controller” and “controller” as used herein refers to hardware that executes a software program, and does not include a human being.

In an example, the electronic device 20 further includes storage 28. The storage 28 is any computer storage device or any non-transitory computer-readable medium with the sole exception of a transitory, propagating signal. The storage 28 stores a control program and information used for a control process. The storage 28 includes, for example, nonvolatile memory and volatile memory. The electronic controller 26 and the storage 28 are provided, for example, on the substrate 22. The electronic controller 26 stores and reads data and/or programs from the storage 28.

In an example, the electronic device 20 further includes a detector 30. The term “detector” as used herein refers to a hardware device or instrument designed to detect the presence or absence of a particular event, object, substance, or a change in its environment, and to emit a signal in response. The term “detector” as used herein does not include a human being. In an example, the detector 30 is disposed in the accommodation space SA1. The detector 30 is provided, for example, on the substrate 22. In an example, the detector 30 is configured to detect a rotational amount of a rotational body. The rotational body is included in a transmission path of the human driving force in the human-powered vehicle 10. The transmission path of the human driving force includes a pedal, the crank 12A, the front sprocket 18, the chain, the rear sprocket, a rear hub, and the rear wheel.

In the present embodiment, the rotational body includes the crank 12A. In the present embodiment, the detector 30 is configured to detect a rotational amount of the crank 12A. The rotational amount is expressed by a rotational angle of the crank 12A. In an example, in a case where the first crank arm 14A is rotated from the bottom dead center to the top dead center, the rotational amount of the crank 12A is 180 degrees. In a case where the first crank arm 14A is rotated about the rotational axis C1 from the bottom dead center through the top dead center and again to the bottom dead center in one direction, the rotational amount of the crank 12A is 360 degrees. The rotational body can include the crank arm 14,and the detector 30 can be configured to detect a rotational amount of the crank arm 14.

In an example, the detector 30 includes an acceleration sensor 30A. In an example, the acceleration sensor 30A is configured to detect acceleration of three or more axes. The acceleration sensor 30A can include a gyro sensor. In the present embodiment, the acceleration sensor 30A is configured to detect acceleration in three axial directions that are orthogonal to each other. In an example, the three axial directions correspond to a first direction in which the crank arm 14 extends, a second direction that is parallel to the rotational axis C1, and a third direction that is orthogonal to the first direction and the second direction. The acceleration sensor 30A is configured to detect acceleration of the crank 12A in three axial directions.

In an example, the detector 30 is configured to be a sensor package. The detector 30 can include a processor that calculates the rotational amount of the crank 12A from an output of the acceleration sensor 30A. The processor calculates the rotational amount of the crank 12A from acceleration in three axial directions.

In an example, the detector 30 is configured to transmit a second signal to the electronic controller 26. In an example, the second signal is a signal related to the rotational amount calculated from a detection result of the acceleration sensor 30A. In an example, the detector 30 is configured to transmit the second signal to the electronic controller 26 in a case where the rotational amount becomes a predetermined third rotational amount. The detector 30 includes storage that stores information related to the predetermined third rotational amount. The predetermined third rotational amount can be changed by rewriting the information related to the predetermined third rotational amount stored in the storage of the detector 30. In an example, the third rotational amount is greater than 0 degrees and less than or equal to 50 degrees. Preferably, the third rotational amount is greater than 10 degrees and less than or equal to 40 degrees. As the third rotational amount increases, the detector 30 is less likely to output the second signal that corresponds to unintentional movement of the rotational body. As the third rotational amount decreases, the detector 30 promptly outputs the second signal related to the rotational amount.

In an example, the electronic device 20 further includes a human force sensor 32. In an example, the human force sensor 32 is disposed in the accommodation space SA1. The human force sensor 32 is disposed so as to detect a human driving force. In an example, the human force sensor 32 is configured to be provided on at least one of the crank arm 14 of the human-powered vehicle 10 and the pedal of the human-powered vehicle 10. In the present embodiment, the human force sensor 32 is provided on the crank arm 14 of the human-powered vehicle 10. In an example, the human force sensor 32 is configured to output a signal corresponding to the human driving force. The human force sensor 32 outputs the detected human driving force.

The human force sensor 32 includes at least one strain gauge 32A. The at least one strain gauge 32A is configured to detect information related to the human driving force applied to the crank 12A in the circumferential direction with respect to the rotational axis C1. The human driving force that is input to the pedals and transmitted to the crank axle 16 generates strain acting on the crank arms 14. The at least one strain gauge 32A detects strain of at least one of the crank arms 14 in the circumferential direction with respect to the rotational axis C1. The at least one strain gauge 32A outputs a signal corresponding to the detected strain of at least one of the crank arms 14.

The at least one strain gauge 32A is disposed so as to detect strain with respect to at least the rotational axis C1 in the circumferential direction. The at least one strain gauge 32A can be disposed to detect strain in at least one of the circumferential direction with respect to the rotational axis C1, a radial direction with respect to the rotational axis C1, and an axial direction. The number of at least one strain gauge 32A is determined in accordance with the directions in which strain is detected. In the present embodiment, the at least one strain gauge 32A includes four strain gauges 32A.

In an example, the human-powered vehicle 10 further includes a battery 34. In the present embodiment, the electronic device 20 includes the battery 34. The electronic device 20 can include a battery holder configured to hold the battery 34 in a detachable manner. In an example, the battery 34 is disposed in the accommodation space SA1. The battery 34 is configured to supply electric power to the electronic controller 26. The battery 34 includes one or more battery elements. In the present embodiment, the battery 34 is a rechargeable battery. The battery 34 can be a non-rechargeable battery, such as a coin battery, that is only discharged.

In an example, the electronic device 20 further includes a flexible print wiring substrate 36. The flexible print wiring substrate 36 electrically connects the human force sensor 32 and the substrate 22. The flexible print wiring substrate 36 is electrically connected to the substrate 22 and the battery 34.

In an example, the electronic device 20 further includes an electric power input portion 34A and a battery cover member 34B. Electric power is input to the electric power input portion 34A to charge the battery 34. The electric power input portion 34A includes at least one of an electric terminal, an electric cable, and an electric connector. The battery cover member 34B forms part of the cover member 24. The battery cover member 34B is attached to a different part of the cover member 24 in a detachable manner. In a state in which the battery cover member 34B is attached to the different part of the cover member 24, the battery cover member 34B is configured to cover the electric power input portion 34A. In a state in which the battery cover member 34B is detached from the different part of the cover member 24, the electric power input portion 34A is exposed from the cover member 24.

In an example, the electronic device 20 includes a wireless communication device 38. In an example, the wireless communication device 38 is disposed in the accommodation space SA1. The wireless communication device 38 includes an antenna. In an example, the wireless communication device 38 is configured to perform communication using a communication method including at least one of Bluetooth®, ANT®, Wi-Fi®, and infrared communication. The wireless communication device 38 can be configured to perform communication using an original communication method that differs from Bluetooth®, ANT+®, Wi-Fi®, and versatile infrared communication.

The wireless communication device 38 is configured to perform wireless communication with an external device 40. The wireless communication device 38 is electrically connected to the electronic controller 26 by a wire pattern of the substrate 22. The wireless communication device 38 is configured to receive a wireless signal that is transmitted from the external device 40 to the electronic device 20 and is configured to input information corresponding to the received wireless signal to the electronic controller 26. The wireless communication device 38 is configured to transmit a signal that is output from the electronic controller 26 in the form of a wireless signal to the external device 40.

The external device 40 is configured to show information related to the component 12 of the human-powered vehicle 10 in accordance with the wireless signal received from the wireless communication device 38. In an example, the external device 40 includes at least one of a display, a cycle computer, a smartphone, a tablet computer, and a personal computer. The external device 40 can be configured to control a human-powered vehicle component differing from the component 12 in accordance with a wireless signal received from the wireless communication device 38. The differing human-powered vehicle component includes, for example, a drive unit. The drive unit includes a motor configured to apply a propulsion force to the human-powered vehicle 10.

The electronic controller 26 is electrically connected to the battery 34 by a printed wire of the substrate 22 and the flexible print wiring substrate 36. The electronic controller 26 is supplied with electric power from the battery 34 through the printed wire of the substrate 22 and the flexible print wiring substrate 36.

The electronic controller 26 is electrically connected to the detector 30. In an example, the electronic controller 26 is electrically connected to the detector 30 by at least one first electrical connection member P1. In an example, the at least one first electrical connection member P1 is configured to send electric power from the battery 34 to the detector 30 and transmit the second signal that is output from the detector 30. The at least one first electrical connection member P1 can be formed by, for example, the printed wire of the substrate 22. In an example, the electronic controller 26 is configured to supply electric power to the detector 30 from the battery 34 through the first electrical connection member P1. In an example, the detector 30 outputs the second signal to the electronic controller 26 through the first electrical connection member P1.

In an example, the electronic controller 26 is configured to output information related to the rotational speed of the rotational body in accordance with the rotational amount. In an example, in a case where a second signal is input, the electronic controller 26 calculates rotational speed of the rotational body from the second signal and outputs a signal corresponding to the rotational speed of the rotational body to the wireless communication device 38.

In an example, the electronic controller 26 is connected to the human force sensor 32. In an example, the electronic controller 26 is electrically connected to the human force sensor 32 by at least one second electrical connection member P2. In an example, the at least one second electrical connection member P2 is configured to send electric power from the battery 34 to the human force sensor 32 and transmit a signal that is output from the human force sensor 32. The second electrical connection member P2 can be formed by, for example, a printed wire of the substrate 22. In an example, the electronic controller 26 is configured to supply electric power from the battery 34 to the human force sensor 32 through the second electrical connection member P2. In an example, the human force sensor 32 outputs a third signal to the electronic controller 26 through the second electrical connection member P2.

In an example, the electronic controller 26 is configured to output information related to the human driving force in accordance with the third signal received from the human force sensor 32. In an example, in a case where a third signal is input, the electronic controller 26 calculates the human driving force from the third signal and outputs a signal corresponding to the calculated human driving force to the wireless communication device 38.

In an example, the electronic controller 26 calculates the rotational speed of the rotational body from the third signal received from the human force sensor 32. In an example, the electronic controller 26 calculates the rotational speed of the crank 12A from the third signal received from the human force sensor 32. In an example, the electronic controller 26 calculates the rotational speed of the crank 12A based on characteristics of changes in the human driving force in accordance with rotation of the crank 12A. In an example, the electronic controller 26 calculates the rotational speed of the crank 12A based on the time from a point where the human driving force reaches a peak value to a point where the human driving force reaches the next peak value. The point in time where the human driving force reaches a peak value is a point in time where the first crank arm 14A has been rotated 90 degrees from the top dead center or the bottom dead center about the rotational axis C1 in one direction. In a case where the rotational speed of the rotational body is calculated from the third signal received from the human force sensor 32, the electronic controller 26 can be configured to output a signal corresponding to the rotational speed of the rotational body calculated from the third signal to the wireless communication device 38 instead of calculating the rotational speed of the rotational body from the second signal.

In an example, an acceleration signal related to acceleration detected by the acceleration sensor 30A can be configured to be transmitted to the electronic controller 26, and the electronic controller 26 can be configured to calculate the rotational speed of the rotational body from the acceleration signal received from the acceleration sensor 30A. In an example, the acceleration signal differs from the second signal. In an example, the acceleration signal is input to the electronic controller 26 in a period shorter than the second signal. In an example, the electronic controller 26 calculates the rotational speed of the crank 12A from the acceleration signal received from the acceleration sensor 30A. In an example, the electronic controller 26 calculates the rotational speed of the crank 12A based on characteristics of changes in acceleration in accordance with rotation of the crank 12A. In an example, the electronic controller 26 calculates the rotational speed of the crank 12A based on the time from a point where acceleration reaches a peak value to a point where acceleration reaches the next peak value. In a case where the rotational speed of the rotational body is calculated from the acceleration signal received from the acceleration sensor 30A, the electronic controller 26 can be configured to output a signal corresponding to the rotational speed of the rotational body calculated from the acceleration signal to the wireless communication device 38 instead of calculating the rotational speed of the rotational body from the second signal.

The electronic controller 26 is configured to selectively operate in an operational state that includes a first operational state and a second operational state. The second operational state consumes more electric power than the first operational state. In an example, in a case where the electronic controller 26 operates in the second operational state, the electronic device 20 consumes more electric power than in a case where the electronic controller 26 operates in the first operational state.

In an example, in the first operational state, the electronic controller 26 reduces the amount of electric power supplied to at least one of the human force sensor 32, and the wireless communication device 38 as compared to the second operational state so that the power consumption is reduced. In an example, in the first operational state, the electronic controller 26 stops the supply of electric power to at least one of the human force sensor 32, and the wireless communication device 38 as compared to the second operational state so that the power consumption is reduced. In an example, in the first operational state, the electronic controller 26 reduces the electric power consumed by the electronic controller 26 as compared to the second operational state. In an example, the first operational state corresponds to a mode in which the functions of the electronic device 20 are partially deactivated. In an example, the first operational state corresponds to a mode in which all of the functions of the electronic device 20 are activated. In the present embodiment, the first operational state corresponds to a sleep mode.

In an example, in the first operational state, the electronic controller 26 is configured to be supplied with electric power from the battery 34. In the first operational state, the electronic controller 26 supplies electric power from the battery 34 to the detector 30. In the second operational state, the electronic controller 26 is configured to be supplied with electric power from the battery 34. Alternatively, the electric power can be supplied from the battery 34 to the detector 30 without using the electronic controller 26. In the second operational state, the electronic controller 26 supplies electric power from the battery 34 to the detector 30. In the second operational state, the electronic controller 26 supplies electric power from the battery 34 to the human force sensor 32.

The electronic controller 26 is configured to switch the operational state between the first operational state and the second operational state in accordance with the rotational amount of the rotational body. In the present embodiment, in a case where the second signal is input in the first operational state, the electronic controller 26 is configured to switch the operational state to the second operational state. In the present embodiment, a first rotational amount is equal to the third rotational amount.

In an example, the first rotational amount includes at least one of the rotational amount of a case where the crank 12A is rotated in a first rotational direction that corresponds to a forward direction of the human-powered vehicle 10 and the rotational amount of a case where the crank 12A is rotated in a second rotational direction that is opposite to the first rotational direction. In the present embodiment, the first rotational amount includes both the rotational amount of a case where the crank 12A is rotated in the first rotational direction and the rotational amount of a case where the crank 12A is rotated in the second rotational direction. In the present embodiment, the detector 30 is configured to transmit the second signal to the electronic controller 26 in a case where the rotational amount of a case where the crank 12A is rotated in the first rotational direction or a case where the crank 12A is rotated in the second rotational direction becomes the predetermined third rotational amount.

In an example, in a case where rotation of the crank 12A by the third rotational amount in the first rotational direction is detected, the detector 30 outputs the second signal to the electronic controller 26. In an example, in a case where rotation of the crank 12A by the third rotational amount in the second rotational direction is detected, the detector 30 outputs the second signal to the electronic controller 26.

In an example, the first rotational amount is greater than 0 degrees and less than or equal to 50 degrees. In an example, the first rotational amount is greater than or equal to 10 degrees and less than or equal to 40 degrees. In an example, the first rotational amount is 35 degrees. In an example, the first rotational amount is set to a rotational amount of the crank 12A rotated in a case where the user intends to rotate the crank 12A. In an example, the first rotational amount is set so that the electronic controller 26 does not switch the operational state in a case where the crank 12A is slightly moved by vibration or the like. As the first rotational amount increases, the control state of the electronic controller 26 is less likely to be switched from the first operational state to the second operational state with no such intention of the user. As the first rotational amount decreases, the time from where the human-powered vehicle 10 starts traveling with the human driving force input to the crank 12A until the human force sensor 32 starts to detect the human driving force becomes shorter.

In an example, in a case where the operational state is the first operational state and the rotational amount becomes the first rotational amount or greater, the electronic controller 26 is configured to switch the operational state from the first operational state to the second operational state. In a case where the operational state is the first operational state, the electronic controller 26 is configured to switch the operational state in accordance with the second signal. In a case where the operational state is the first operational state and the rotational amount becomes the first rotational amount or greater, the electronic controller 26 starts to supply electric power from the battery 34 to the human force sensor 32.

In an example, in a case where the operational state is the first operational state after having been switched from the second operational state to the first operational state and the rotational amount then becomes greater than or equal to the first rotational amount, the electronic controller 26 is configured to switch the operational state from the first operational state to the second operational state. The detector 30 detects the rotational amount of the crank axle 16 from the position of the crank axle 16 where the operational state of the electronic controller 26 is switched from the second operational state to the first operational state.

In an example, in a case where the operational state is the second operational state and a predetermined condition is satisfied, the electronic controller 26 is configured to switch the operational state from the second operational state to the first operational state. The predetermined condition is a condition corresponding to a state in which the human driving force is not input to the crank 12A. In an example, the predetermined condition includes at least one of a first condition, a second condition, and a third condition. In the present embodiment, the predetermined condition includes the first condition, the second condition, and the third condition. In a case where the operational state is the second operational state and one of the first condition, the second condition, and the third condition is satisfied, the electronic controller 26 is configured to switch the operational state.

In an example, the predetermined condition includes the first condition. In an example, the first condition is that the rotational amount in a first period is less than a second rotational amount. The first period and the second rotational amount are changeable and stored in the storage 28. In an example, the first period is greater than 0 minutes and less than or equal to 10 minutes. In an example, the first period is greater than or equal to 5 minutes and less than or equal to 8 minutes.

The second rotational amount includes at least one of the rotational amount of a case where the crank 12A is rotated in the first rotational direction and the rotational amount of a case where the crank 12A is rotated in the second rotational direction. In the present embodiment, the second rotational amount includes the rotational amount of a case where the crank 12A is rotated in the first rotational direction and the rotational amount of a case where the crank 12A is rotated in the second rotational direction. In the present embodiment, the second rotational amount is equal to the first rotational amount. The second rotational amount can differ from the first rotational amount. In an example, the second rotational amount is greater than 0 degrees and less than or equal to 50 degrees. In an example, the second rotational amount is greater than or equal to 10 degrees and less than or equal to 40 degrees.

In an example, the predetermined condition includes the second condition. In an example, the second condition is that human driving force in a second period is less than or equal to a predetermined human driving force. The second period and the predetermined human driving force are changeable and stored in the storage 28. The second period can be set to be the same period as the first period. In an example, the second period is greater than 0 minutes and less than or equal to 10 minutes. In an example, the second period is greater than or equal to 5 minutes and less than or equal to 8 minutes. The predetermined human driving force corresponds to the human driving force that is less than needed to cause the human-powered vehicle 10 to travel. In an example, the predetermined human driving force corresponds to a value of rotational torque of the crank arm 14 in a range from 3 Nm to 7 Nm.

In an example, the predetermined condition includes the third condition. In an example, the third condition is that a predetermined first signal is not input to the electronic controller 26 in a third period. The third period is changeable and stored in the storage 28. The third period can be set to be the same period as the first period or the second period. In an example, the third period is greater than 0 minutes and less than or equal to 10 minutes. In an example, the third period is greater than or equal to 5 minutes and less than or equal to 8 minutes.

In an example, the predetermined first signal includes a wireless communication signal. The wireless communication signal is a signal that is received by the wireless communication device 38. The wireless communication device 38 receives the wireless communication signal from the external device 40 and outputs the wireless communication signal to the electronic controller 26. The predetermined first signal is a signal that is transmitted from the external device 40 to the wireless communication device 38. In an example, the predetermined first signal is a signal used to control the electronic device 20 from the external device 40. In an example, the signal used to control the electronic device 20 from the external device 40 includes a signal that switches the operational state of the electronic device 20 from the first operational state to the second operational state. In a case where the user operates the external device 40, the predetermined first signal is transmitted from the external device 40 to the wireless communication device 38.

A process for controlling the electronic device 20 with the electronic controller 26 will now be described with reference to the flowchart shown in FIG. 5. In an example, in a case where electric power is supplied to the electronic controller 26, the electronic controller 26 starts the process and proceeds to step S11 of the flowchart shown in FIG. 5.

In step S11, the electronic controller 26 determines whether the operational state is the first operational state. In a case where the operational state is the first operational state, the electronic controller 26 proceeds to step S12.

In step S12, the electronic controller 26 determines whether the second signal is received. In a case where the second signal is not received, the electronic controller 26 ends the process. In a case where the second signal is received, the electronic controller 26 proceeds to step S13. In step S13, the electronic controller 26 switches the operational state to the second operational state and ends the process.

In step S11, in a case where the operational state is not the first operational state, the electronic controller 26 proceeds to step S14. In step S14, the electronic controller 26 determines whether the predetermined condition is satisfied. In a case where the predetermined condition is not satisfied, the electronic controller 26 ends the process. In a case where the predetermined condition is satisfied, the electronic controller 26 proceeds to step S15. In step S15, the electronic controller 26 switches the operational state to the first operational state and ends the process.

Since the electric power of the battery 34 is efficiently used, the electronic device 20 can be operated in the first operational state over a relatively long period of time in a case where the crank 12A is not rotated. Since the acceleration sensor 30A detects the rotational amount of the rotational body, the electronic controller 26 accurately determines that the crank 12A is not rotating.

In the present embodiment, the detector 30 detects the rotational amount with the acceleration sensor 30A without a magnet or the like provided outside the detector 30. This limits increases in the size of the detector 30 and the component 12.

### Second Embodiment

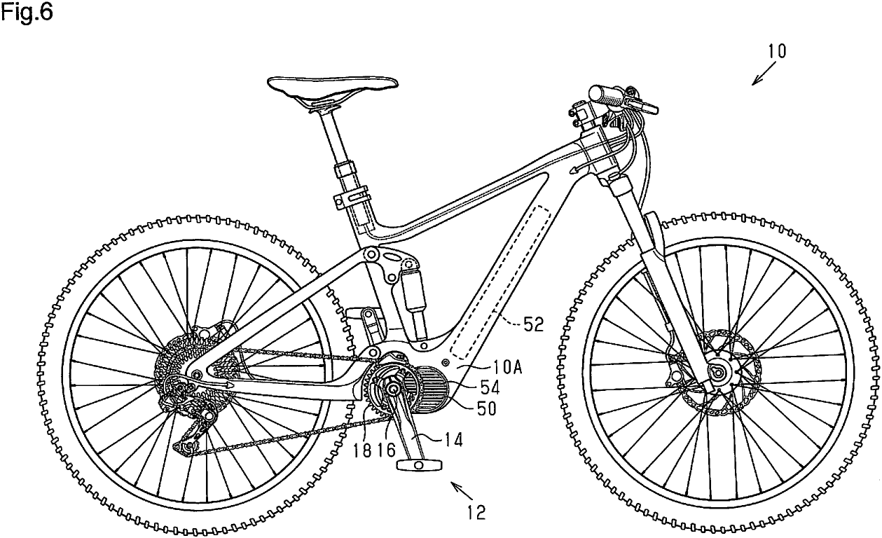

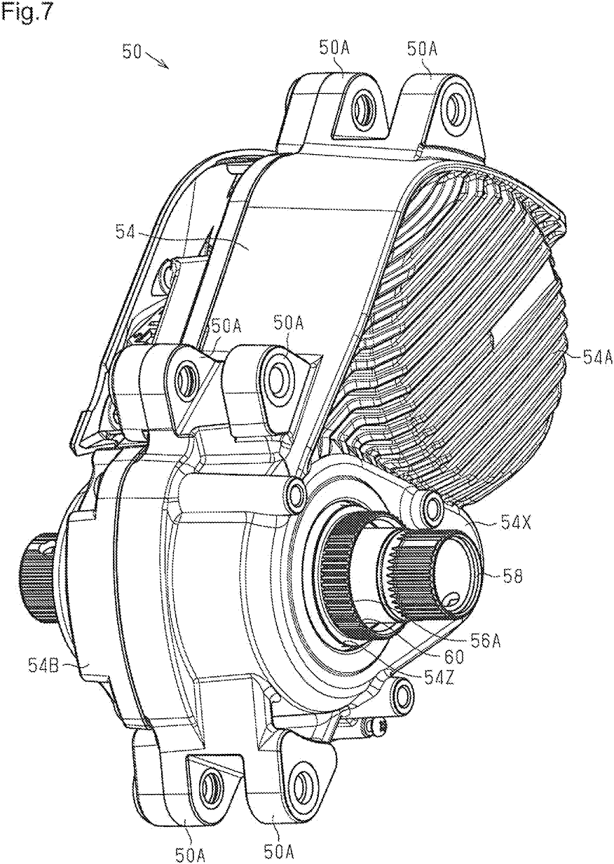

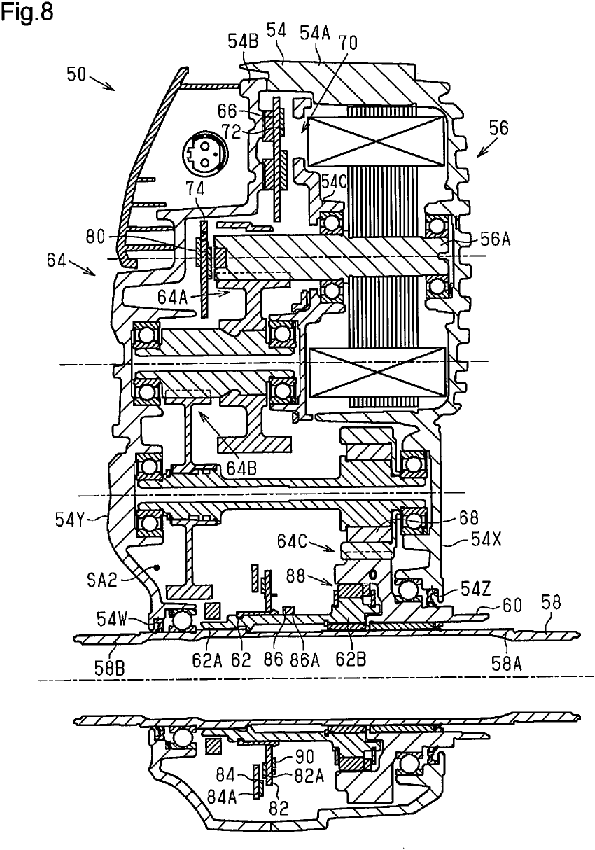

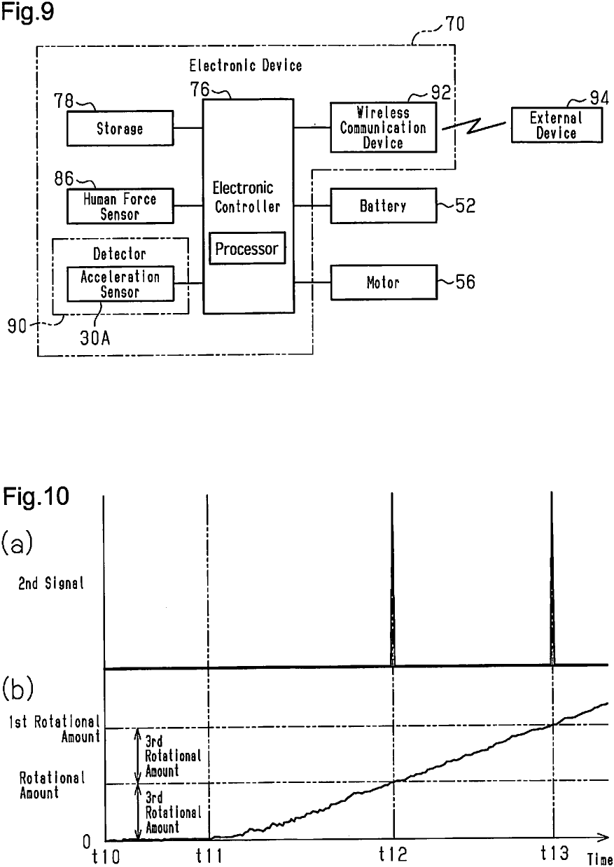

A second embodiment of an electronic device 70 will now be described with reference to FIGS. 6 to 9. The electronic device 70 of the second embodiment is the same as the electronic device 20 of the first embodiment except in that the electronic device 70 is disposed on a drive unit 50. Same reference characters are given to those elements that are the same as the corresponding elements of the first embodiment. Such elements will not be described in detail.

The human-powered vehicle 10 of the present embodiment includes the drive unit 50. The human-powered vehicle 10 of the present embodiment further includes a battery 52 that supplies electric power to the drive unit 50. The battery 52 includes one or more battery elements. The battery element includes a rechargeable battery. The battery 52 supplies electric power to the drive unit 50. The battery 52 is connected to an electronic controller 76 of the drive unit 50 by an electric cable or a wireless communicator to communicate with the electronic controller 76. The battery 52 is configured to communicate with the electronic controller 76 through, for example, power line communication (PLC), controller area network (CAN), or universal asynchronous receiver/transmitter (UART).

The drive unit 50 includes a housing 54 and a motor 56. The motor 56 is provided on the housing 54. In an example, the motor 56 applies propulsion force to the human-powered vehicle 10. The motor 56 includes one or more electric motors. The electric motor is, for example, a brushless motor. In the present embodiment, the electric motor is an inner rotor type motor. In the present embodiment, the motor 56 is configured to transmit rotation to the front sprocket 18.

In the present embodiment, the housing 54 includes a first housing 54A, a second housing 54B, and a cover member 54C. The first housing 54A includes a first side surface 54X. The second housing 54B includes a second side surface 54Y. The first housing 54A and the second housing 54B define an accommodation space SA2. In an example, the first housing 54A and the second housing 54B are bolted to each other.

The motor 56, part of an input shaft 58, part of an output portion 60, a power transmission member 62, a speed reducer 64, and a first circuit substrate 66 are disposed in the accommodation space SA2 of the housing 54. In the present embodiment, the first housing 54A is used as the case of the motor 56. The cover member 54C is provided on the first housing 54A and defines a motor space together with the first housing 54A. In an example, the cover member 54C is bolted to the first housing 54A. The cover member 54C has a through hole through which an output shaft 56A of the motor 56 is inserted. The cover member 54C has a through hole through which a terminal or a cable is inserted so that the terminal or the cable connects a coil of the motor 56 to an inverter circuit.

The drive unit 50 includes a coupling portion 50A used for attachment to the frame 10A of the human-powered vehicle 10. The coupling portion 50A is provided on the housing 54. The frame 10A has a hole for attaching the drive unit 50 in a location corresponding to the coupling portion 50A of the drive unit 50. In an example, the hole in the frame 10A is a through hole.

In an example, a bolt is inserted into the hole of the frame 10A and is coupled to the coupling portion 50A, so that the drive unit 50 is coupled to the frame 10A. The coupling portion 50A can be a non-threaded through hole. In a case where the coupling portion 50A is a through hole, the hole in the frame 10A is a non-threaded hole or a threaded hole. In a case where the hole in the frame 10A is a non-threaded through hole, the drive unit 50 is coupled to the frame 10A by a bolt and a nut.

The housing 54 supports the input shaft 58 to which the human driving force is input. In the present embodiment, the input shaft 58 is the crank axle 16. The housing 54 rotatably supports the input shaft 58. The human driving force is input to the input shaft 58. The housing 54 includes a first hole 54Z and a second hole 54W into which the input shaft 58 is inserted. The first hole 54Z and the second hole 54W connect the space surrounded by the housing 54 and the space outside the housing 54.

The first hole 54Z extends through the first side surface 54X of the housing 54 in an axial direction of the input shaft 58. The second hole 54W extends through the second side surface 54Y of the housing 54 in the axial direction of the input shaft 58. The input shaft 58 has a first end 58A in the axial direction projecting from the first hole 54Z to the space outside the housing 54. The input shaft 58 has a second end 58B in the axial direction projecting from the second hole 54W to the space outside the housing 54.

In the present embodiment, the input shaft 58 is the crank axle 16. The output portion 60 has the rotational axis C1 and is configured to receive rotational force from the input shaft 58. The drive unit 50 further includes the power transmission member 62. The power transmission member 62 is configured to transmit rotational force that is input to the input shaft 58 to the output portion 60. The power transmission member 62 connects the input shaft 58 and the output portion 60. The power transmission member 62 can be connected to the input shaft 58 directly or indirectly. In the present embodiment, the power transmission member 62 is substantially cylindrical.

The power transmission member 62 is disposed to surround the circumferential portion of the input shaft 58 about the axis of the input shaft 58. In the present embodiment, the power transmission member 62 includes a first end 62A in the axial direction of the input shaft 58, and the first end 62A is directly connected to the circumferential portion of the input shaft 58. The first end 62A of the power transmission member 62 and the circumferential portion of the input shaft 58 include splines that engage with each other. In the present embodiment, the power transmission member 62 includes a second end 62B in the axial direction of the input shaft 58, and the second end 62B is connected to the output portion 60 by a first one-way clutch 68.

In an example, the speed reducer 64 includes reduction parts. In an example, the speed reducer 64 includes a first reduction part 64A, a second reduction part 64B, and a third reduction part 64C. The first reduction part 64A, the second reduction part 64B, and the third reduction part 64C each reduce the speed of rotation of the motor 56 with gears.

The drive unit 50 includes the electronic device 70. The electronic device 70 is provided in the housing 54. The electronic device 70 includes the first circuit substrate 66, at least one first electronic component 72, and a second circuit substrate 74. The at least one first electronic component 72 forms at least part of an inverter circuit configured to supply electric power to the motor 56. The at least one first electronic component 72 is provided on the first circuit substrate 66.

The electronic device 70 includes the electronic controller 76. The electronic controller 76 includes a processor that executes a predetermined control program. The processor includes, for example, a CPU or an MPU. The electronic controller 76 can include one or more microcomputers. The electronic controller 76 can include multiple processors located at separate positions.

The electronic device 70 further includes storage 78. The storage 78 stores a control program and information used for a control process. The storage 78 includes, for example, nonvolatile memory and volatile memory. The electronic controller 76 and the storage 78 are provided, for example, on the housing 54.

The electronic controller 76 is configured to control the motor 56. In the present embodiment, the electronic controller 76 has the same configuration as the electronic controller 26 of the first embodiment except that the electronic controller 76 is configured to control the motor 56. The electronic controller 76 includes at least one second electronic component 80 and is electrically connected to an inverter circuit to control the inverter circuit. The second circuit substrate 74 is formed separately from the first circuit substrate 66. The at least one second electronic component 80 of the electronic controller 76 is provided on the second circuit substrate 74.

The at least one first electronic component 72 can be provided on one mount surface of the first circuit substrate 66 or both of two opposing mount surfaces of the first circuit substrate 66. In an example, the at least one first electronic component 72 includes at least one of a semiconductor element, a capacitor, a resistive element, and an inductor.

The at least one second electronic component 80 of the electronic controller 76 can be provided on one mount surface of the second circuit substrate 74 or both of two opposing mount surfaces of the second circuit substrate 74. Most of the electronic components forming the inverter circuit is provided on the second circuit substrate 74. All of the electronic components forming the inverter circuit is provided on the second circuit substrate 74.

The electronic device 70 further includes a third circuit substrate 82 that is formed separately from the first circuit substrate 66 and the second circuit substrate 74. The third circuit substrate 82 includes a wireless transmitter 82A configured to transmit information related to the human driving force that is transmitted to the input shaft 58.

The electronic device 70 further includes a fourth circuit substrate 84 that is formed separately from the first circuit substrate 66, the second circuit substrate 74, and the third circuit substrate 82. At least one of the substrates of the electronic device 70 can include a printed wiring substrate. The fourth circuit substrate 84 includes a wireless receiver 84A configured to receive information related to the human driving force. The fourth circuit substrate 84 is electrically connected to at least one of the first circuit substrate 66 and the second circuit substrate 74.

In an example, the electronic device 70 further includes a human force sensor 86. In an example, the human force sensor 86 is configured to output a signal corresponding to the human driving force. In the present embodiment, the human force sensor 86 includes a torque sensor 86A. The torque sensor 86A is configured to output a signal corresponding to torque applied to the crank axle 16 by the human driving force. In an example, in a case in which a second one-way clutch 88 is provided on the power transmission path, the torque sensor 86A is provided at the upstream side of the second one-way clutch 88 in the power transmission path.

In the present embodiment, the torque sensor 86A is provided on the power transmission member 62. The torque sensor 86A can be provided on the input shaft 58. The torque sensor 86A includes, for example, a strain sensor or a pressure sensor. The strain sensor includes a strain gauge. In the present embodiment, the torque sensor 86A is attached to an outer circumference of the power transmission member 62 and is electrically connected to the third circuit substrate 82 by, for example, a flexible printed wiring substrate.

The torque sensor 86A can be provided in the vicinity of a member included in the power transmission path instead of being provided on the power transmission member 62. In this case, the torque sensor 86A can be, for example, a magnetostrictive sensor. In an example, in a case where the torque sensor 86A is a magnetostrictive sensor, an magnetostrictive element is provided on the circumferential portion of the power transmission member 62, and the magnetostrictive sensor is provided around the circumferential portion of the power transmission member 62. In a case where the torque sensor 86A is a magnetostrictive sensor, the third circuit substrate 82 and the fourth circuit substrate 84 can be omitted.

In an example, the electronic device 70 further includes a detector 90. The detector 90 has the same configuration as the detector 30 of the first embodiment except that the detector 90 is provided on the third circuit substrate 82 and is configured to rotate with the input shaft 58 and detect a rotational amount of the input shaft 58. In the present embodiment, the rotational body is the input shaft 58. The rotational body of the present embodiment can be a rotational body that differs from the input shaft 58 as long as the rotational body is included in the transmission path of the human driving force in the human-powered vehicle 10. The transmission path of the human driving force is the power transmission path located between the output portion 60 and the input shaft 58.

The wireless transmitter 82A includes a first signal processing circuit and a first antenna. The first signal processing circuit processes the second signal and a signal output from the torque sensor 86A and transmits information related to the human driving force from the first antenna. The wireless receiver 84A includes a second signal processing circuit and a second antenna. The second antenna is disposed to face the first antenna. Each of the first antenna and the second antenna includes, for example, a coil antenna. The second signal processing circuit transmits information related to the human driving force that is received by the second antenna to the electronic controller 76. The fourth circuit substrate 84 is electrically connected to the first circuit substrate 66. In an example, the fourth circuit substrate 84 is electrically connected to the first circuit substrate 66 by a connector or an electric cable.

In an example, the electronic device 70 includes a wireless communication device 92. In an example, the wireless communication device 92 is configured to perform communication using a communication method including at least one of Bluetooth@, ANT+®, Wi-Fi®, and infrared communication. The wireless communication device 92 can be configured to perform communication using an original communication method differing from Bluetooth®, ANT+®, Wi-Fi®, and versatile infrared communication.

The wireless communication device 92 is configured to perform wireless communication with an external device 94. The wireless communication device 92 is electrically connected to the electronic controller 76 by at least one of an electric cable and a wire pattern of a substrate included in the electronic device 70. The wireless communication device 92 is configured to receive a wireless signal that is transmitted from the external device 94 to the electronic device 70 and is configured to input information corresponding to the received wireless signal to the electronic controller 76. The wireless communication device 92 is configured to transmit a signal that is output from the electronic controller 76 in the form of a wireless signal to the external device 94.

The external device 94 is configured to control a human-powered vehicle component other than the drive unit 50 in accordance with a wireless signal transmitted from the wireless communication device 92. In an example, the external device 94 includes at least one of a display, a cycle computer, a smartphone, a tablet computer, and a personal computer. The external device 94 can be configured to show information related to a human-powered vehicle component other than the drive unit 50 in accordance with a wireless signal that is transmitted from the wireless communication device 92.

In the present embodiment, in a case where the operational state is the second operational state, the electronic controller 76 can be configured to connect an electric power supply circuit between the battery 52 and the motor 56. In the present embodiment, in a case where the operational state is the first operational state, the electronic controller 76 can be configured to disconnect the electric power supply circuit between the battery 52 and the motor 56. In the present embodiment, the first operational state corresponds to a sleep mode.

### Modifications

The description related to the above embodiments exemplifies, without any intention to limit, applicable forms of a human-powered vehicle electronic device according to the present disclosure. The human-powered vehicle electronic device according to the present disclosure can be applied to, for example, modifications of the embodiments that are described below and combinations of at least two of the modifications that do not contradict each other. In the following modifications, same reference characters are given to those elements that are the same as the corresponding elements of the above embodiments. Such elements will not be described in detail.

The electronic controllers 26 and 76 can be configured to operate in a third operational state that differs from the first operational state and the second operational state. In an example, the third operational state consumes less electric power than the first operational state. In an example, the electronic controllers 26 and 76 are configured not to supply electric power from the batteries 34 and 52 in the third operational state. In a case where the operational state is the first operational state and satisfies a fourth condition, a fifth condition, or a sixth condition, the electronic controllers 26 and 76 are configured to switch the operational state from the first operational state to the third operational state. The fourth condition is that the rotational amount in a fourth period is less than a second rotational amount. The fourth period is longer than the first period. The fifth condition is that human driving force in a fifth period is less than or equal to a predetermined human driving force. The fifth period is longer than the second period. The sixth condition is that the predetermined first signal is not input to the electronic controllers 26 and 76 in a sixth period. The sixth period is longer than the third period.

In the second embodiment, the human-powered vehicle 10 can include the electronic device 20 of the first embodiment. The electronic device 20 is configured to communicate with the electronic controller 76. The electronic device 20 can be configured to transmit the second signal to the electronic controller 76. The electronic controller 76 is configured to switch the operational state between the first operational state and the second operational state in accordance with the second signal received from the electronic device 20.

In the first embodiment, the human force sensor 32 can be provided on a pedal. In an example, in a case where the human force sensor 32 is provided on the pedal, the strain gauge 32A is configured to detect strain of a pedal axle of the pedal.

The first rotational amount can include a rotational amount of only a case where the crank 12A is rotated in the first rotational direction. In an example, the detector 30 can be configured not to output the second signal even in a case where rotation of the crank 12A in the second rotational direction by the third rotational amount is detected.

The first rotational amount can include a rotational amount of only a case where the crank 12A is rotated in the second rotational direction. In an example, the detector 30 can be configured not to output the second signal even in a case where rotation of the crank 12A in the first rotational direction by the third rotational amount is detected.

In the first embodiment, for example, the electronic controller 26 can be configured to accumulate the rotational amount of the rotational body each time the second signal is input. In an example, the first rotational amount can be greater than the third rotational amount and be an integer multiple of the third rotational amount. In an example, the first rotational amount is twice the third rotational amount. Information related to the first rotational amount can be changeable and stored in the storage 28. The electronic controller 26 can be configured to switch the operational state between the first operational state and the second operational state based on a comparison of the first rotational amount with an accumulated value of the rotational amount. In an example, the electronic controller 26 can switch the operational state from the second operational state to the first operational state and then start the accumulation of the rotational amount. In an example, in a case where the operational state is switched from the second operational state to the first operational state, the electronic controller 26 can clear the accumulated value of the rotational amount.

In an example, in a case where the detector 30 detects that the crank 12A is rotated in the first rotational direction by the third rotational amount, the electronic controller 26 adds a predetermined positive numerical value to a rotational amount counter. In an example, in a case where the detector 30 detects that the crank 12A is rotated in the second rotational direction by the third rotational amount, the electronic controller 26 adds a predetermined positive numerical value to a rotational amount counter. The predetermined positive numerical value can correspond to a predetermined angle. In an example, the electronic controller 26 accumulates the rotational amount of the rotational body from a numerical value of the rotational amount counter and the third rotational amount.

The first rotational amount can include only a rotational amount of a case where the crank 12A is rotated in the first rotational direction. In this case, for example, in a case where the detector 30 detects that the crank 12A is rotated in the first rotational direction by the third rotational amount, the electronic controller 26 adds a predetermined positive numerical value to the rotational amount counter. The first rotational amount can include only a rotational amount of a case where the crank 12A is rotated in the first rotational direction. In this case, for example, in a case where the crank 12A is rotated in the second rotational direction, the electronic controller 26 does not execute an addition to the rotational amount counter.

The first rotational amount can include only a rotational amount of a case where the crank 12A is rotated in the first rotational direction. In this case, for example, in a case where the detector 30 detects that the crank 12A is rotated in the second rotational direction by the predetermined angle, the electronic controller 26 can be configured to subtract the predetermined positive numerical value from the rotational amount counter.

The first rotational amount can include only a rotational amount of a case where the crank 12A is rotated in the second rotational direction. In this case, for example, in a case where the detector 30 detects that the crank 12A is rotated in the second rotational direction by the third rotational amount, the electronic controller 26 adds a predetermined positive numerical value to the rotational amount counter. The first rotational amount can include only a rotational amount of a case where the crank 12A is rotated in the first rotational direction. In this case, for example, in a case where the crank 12A is rotated in the first rotational direction, the electronic controller 26 does not add to the rotational amount counter.

The first rotational amount can include only a rotational amount of a case where the crank 12A is rotated in the second rotational direction. In this case, for example, in a case where the detector 30 detects that the crank 12A is rotated in the first rotational direction by the predetermined angle, the electronic controller 26 can be configured to subtract the predetermined positive numerical value from the rotational amount counter.

FIG. 10 shows an example of changes in the rotational amount calculated by the detector 30 in the second operational state and the second signal output from the detector 30 in accordance with time in a case where the electronic controller 26 is configured to accumulate the rotational amount of the rotational body each time the second signal is input.

In FIG. 10, time t10 indicates the time at which the operational state of the electronic controller 26 is switched from the second operational state to the first operational state. At time t10, the accumulated value of the rotational amount is cleared and becomes zero.

Time t11 indicates the time at which the crank 12A starts to rotate. From time t11, as the crank 12A rotates, the accumulated value of the rotational amount increases.

Time t12 indicates the time at which the accumulated value of the rotational amount has reached the third rotational amount. At time t12, the detector 30 transmits the second signal to the electronic controller 26.

Time t13 indicates the time at which the increase amount of the accumulated value of the rotational amount from time t12 has reached the third rotational amount. At time t13, the detector 30 transmits the second signal to the electronic controller 26. In a case where the first rotational amount is twice the third rotational amount, the electronic controller 26 switches the operational state from the first operational state to the second operational state based on the second signal transmitted at time t13.

In this specification, the phrase “at least one of” as used in this disclosure means “one or more” of a desired choice. As one example, the phrase “at least one of” as used in this disclosure means “only one choice” or “both of two choices” in a case where the number of choices is two. In another example, in this specification, the phrase “at least one of” as used in this disclosure means “only one single choice” or “any combination of equal to or more than two choices” if the number of its choices is equal to or more than three.

What is claimed is:

1. An electronic device for a human-powered vehicle, the electronic device comprising:
an electronic controller configured to selectively operate in an operational state that includes a first operational state and a second operational state, the second operational state consuming more electric power than the first operational state,
the electronic controller being further configured to switch the operational state between the first operational state and the second operational state in accordance with a rotational amount of a rotational body included in a transmission path of a human driving force in the human-powered vehicle.

2. The electronic device according to claim 1, wherein
the electronic controller is configured to switch the operational state from the first operational state to the second operational state in a case where the operational state is the first operational state and the rotational amount becomes a first rotational amount or greater.

3. The electronic device according to claim 2, wherein
the electronic controller is configured to switch the operational state from the first operational state to the second operational state in a case where the operational state is the first operational state after having been switched from the second operational state to the first operational state and the rotational amount then becomes greater than or equal to the first rotational amount.

4. The electronic device according to claim 3, wherein
the rotational body includes a crank, and
the first rotational amount includes at least one of the rotational amount of a case in which the crank is rotated in a first rotational direction that corresponds to a forward direction of the human-powered vehicle and the rotational amount of a case in which the crank is rotated in a second rotational direction that is opposite to the first rotational direction.

5. The electronic device according to claim 2, wherein
the first rotational amount is greater than 0 degrees and less than or equal to 50 degrees.

6. The electronic device according to claim 5, wherein
the first rotational amount is greater than or equal to 10 degrees and less than or equal to 40 degrees.

7. The electronic device according to claim 1, wherein
the electronic controller is configured to switch the operational state from the second operational state to the first operational state in a case where the operational state is the second operational state and a predetermined condition is satisfied, and
the predetermined condition includes at least one of a first condition that the rotational amount in a first period is less than a second rotational amount, a second condition that the human driving force in a second period is less than or equal to a predetermined human driving force, and a third condition that a predetermined first signal is not input to the electronic controller in a third period.

8. The electronic device according to claim 7, wherein
the predetermined condition includes the third condition; and
the predetermined first signal includes a wireless communication signal received by a wireless communication device.

9. The electronic device according to claim 1, wherein:
the human-powered vehicle further includes a battery; and
the electronic controller is configured to be supplied with electric power from the battery in the first operational state.

10. The electronic device according to claim 1, further comprising
a detector configured to detect the rotational amount.

11. The electronic device according to claim 10, wherein
the detector includes an acceleration sensor.

12. The electronic device according to claim 11, wherein
the acceleration sensor is configured to detect acceleration of at least three axes.

13. The electronic device according to claim 11, wherein
the detector is configured to transmit a second signal related to the rotational amount calculated from a detection result of the acceleration sensor to the electronic controller.

14. The electronic device according to claim 13, wherein
the detector is configured to transmit the second signal to the electronic controller in a case where the rotational amount becomes a predetermined third rotational amount.

15. The electronic device according to claim 1, further comprising:
a human force sensor configured to output a signal corresponding to the human driving force, and is configured to be provided on at least one of a crank arm of the human-powered vehicle and a pedal of the human-powered vehicle.

16. The electronic device according to claim 15, wherein
the electronic controller is connected to the human force sensor, and is configured to output information related to the human driving force in accordance with a third signal received from the human force sensor.

17. The electronic device according to claim 1, wherein
the electronic controller is configured to control a motor that applies a propulsion force to the human-powered vehicle.

18. The electronic device according to claim 1, wherein
the electronic controller is configured to output information related to rotational speed of the rotational body in accordance with the rotational amount.
